(19) United States
(12) Patent Application Publication
(10) Pub. No.: US 2004/0055471 A1
(43) Pub. Date: Mar. 25, 2004

(54) Mechanism and a method for releasably securing two articles and a coffee maker with such a mechanism

(76) Inventor: Adrian Berry, London (GB)

Correspondence Address: James A. LaBarre, BURNS, DOANE, SWECKER & MATHIS, L.L.P., P.O. Box 1404, Alexandria, VA, 22313-1404, US

(21) Appl. No.: 10/253,490

(22) Filed: Sep. 25, 2002

(51) Int. Cl. A47J 31/00

(52) U.S. Cl. 99/279

(57) ABSTRACT

A mechanism for releasably securing a coffee holder (30) and a boiler (42) of a coffee making machine (16) is disclosed, in which the coffee holder (30) includes a handle (32), a catch (34), and a container (36) with an upwardly facing opening, and the handle (32) is pivotally movable relative to the container (36), and the catch (34) includes an aperture (41) and is movable relative to the handle (32), and the boiler (42) includes a downwardly facing opening and an outwardly extending hook (46), and the upwardly facing opening of the container (36) may be engaged with the downwardly facing opening of the boiler (42), and the hook (46) of the boiler (42) is receivable within the aperture (41) of the catch (34) of the coffee holder (30) when the upwardly facing opening of the container (36) is engaged with the downwardly facing opening of the boiler (42).

This invention relates to a mechanism for releasably securing two articles and a beverage maker incorporating such a mechanism, and in particular such a mechanism allowing the two articles to be releasably secured with each other in a liquid-tight, e.g. water-tight, manner.

There are a large variety of appliances, including e.g. electric coffee makers, which, in use, require two or more parts to be releasably secured with each other or one another. A vital requirement of such engagement mechanisms is that when the parts are so secured, the connection therebetween is water-tight. It is also a requirement that the parts can be secured with, and separated from, each other easily.

It is thus an object of the present invention to provide a novel mechanism and method for releasably securing two articles with each other which fulfill the above requirements. It is a further object of the present invention to provide a coffee maker incorporating such a novel mechanism.

According to a first aspect of the present invention, there is provided a mechanism for releasably securing a first article and a second article with each other, wherein said first article includes a handle member, an engagement member and a container member with an upwardly facing opening, wherein said handle member is movable relative to said container member, wherein said engagement member includes an aperture and is movable relative to said handle member, wherein said second article includes a downwardly facing opening and an outwardly extending engagement element, wherein said upwardly facing opening of said container member is adapted to be engaged with said downwardly facing opening of said second article, wherein said engagement element of said second article is adapted to be received within said aperture of said engagement member of said first article when said upwardly facing opening of said container member is engaged with said downwardly facing opening of said second article.

According to a second aspect of the present invention, there is provided a method for releasably securing a first article and a second article with each other, wherein said first article includes a handle member, an engagement member and a container member with an upwardly facing opening, wherein said handle member is movable relative to said container member, wherein said engagement member includes an aperture and is movable relative to said handle member, wherein said second article includes a downwardly facing opening and an outwardly extending engagement element, including the steps of (a) engaging said upwardly facing opening of said container member with said downwardly facing opening of said second article to allow liquid to pass between said container member and said second article; (b) moving said engagement member to receive at least part of said engagement element within said aperture of said engagement member; and (c) moving said handle member to bring said engagement member into contact with said engagement element.

According to a third aspect of the present invention, there is provided a beverage maker, including a holder and a boiler which are releasably securable with each other, wherein said holder includes a handle member, an engagement member and a container member with an upwardly facing opening, wherein said handle member is movable relative to said container member, wherein said engagement member includes an aperture and is movable relative to said handle member, wherein said boiler includes a downwardly facing opening and an outwardly extending engagement element, wherein said upwardly facing opening of said container member is adapted to be engaged with said downwardly facing opening of said boiler, wherein said engagement element of said boiler is adapted to be received within said aperture of said engagement member of said holder when said upwardly facing opening of said container member is engaged with said downwardly facing opening of said boiler.

An embodiment of the present invention will now be described, by way of an example only, and with reference to the accompanying drawings, in which:

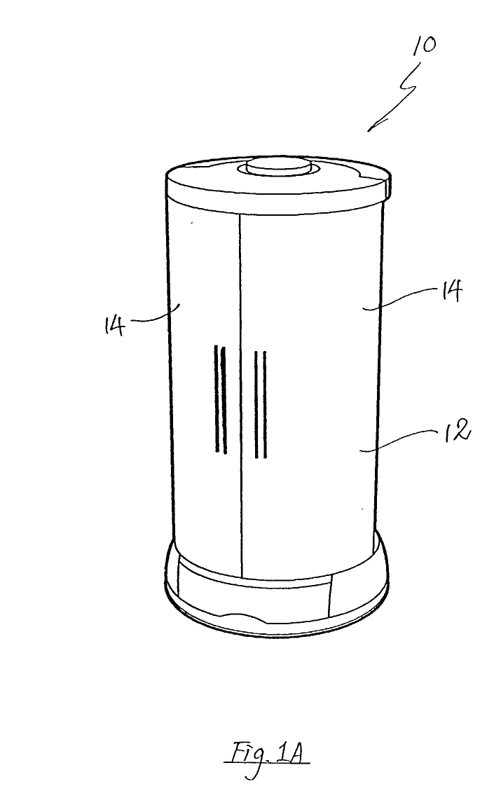

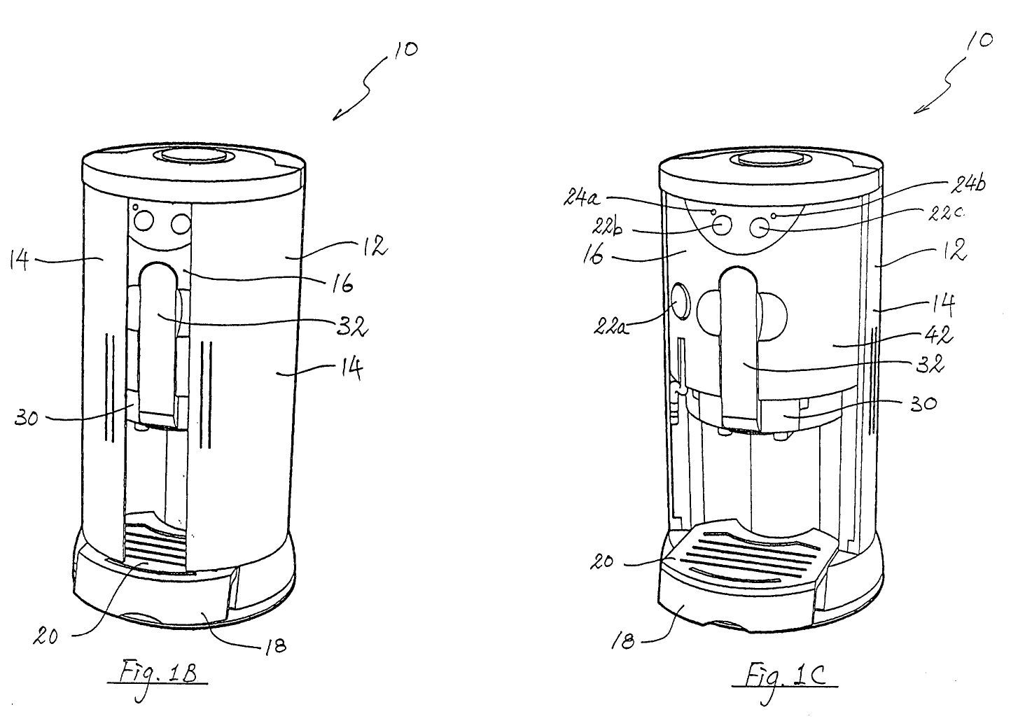

FIG. 1A is a perspective view of an electric coffee maker according to the present invention, showing the doors in a closed position;

FIG. 1B is a perspective view of the electric coffee maker shown in FIG. 1A, showing the doors in a partially open position;

FIG. 1C is a perspective view of the electric coffee maker shown in FIG. 1A, showing the doors in a fully open position;

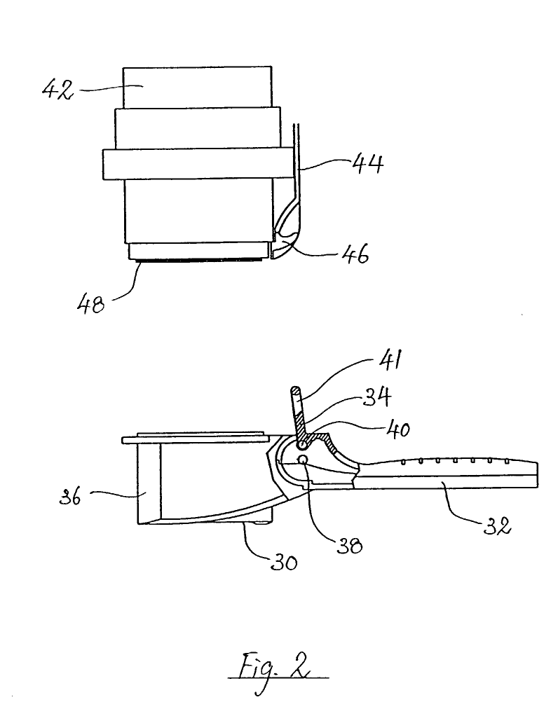

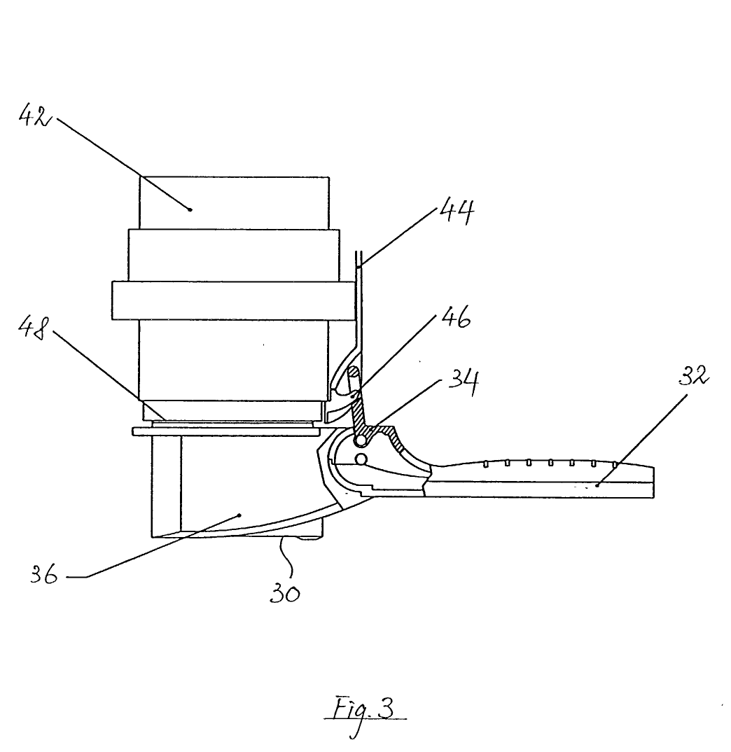

FIG. 2 is a side view of the boiler and coffee holder of the electric coffee maker shown in FIG. 1A, in a detached position;

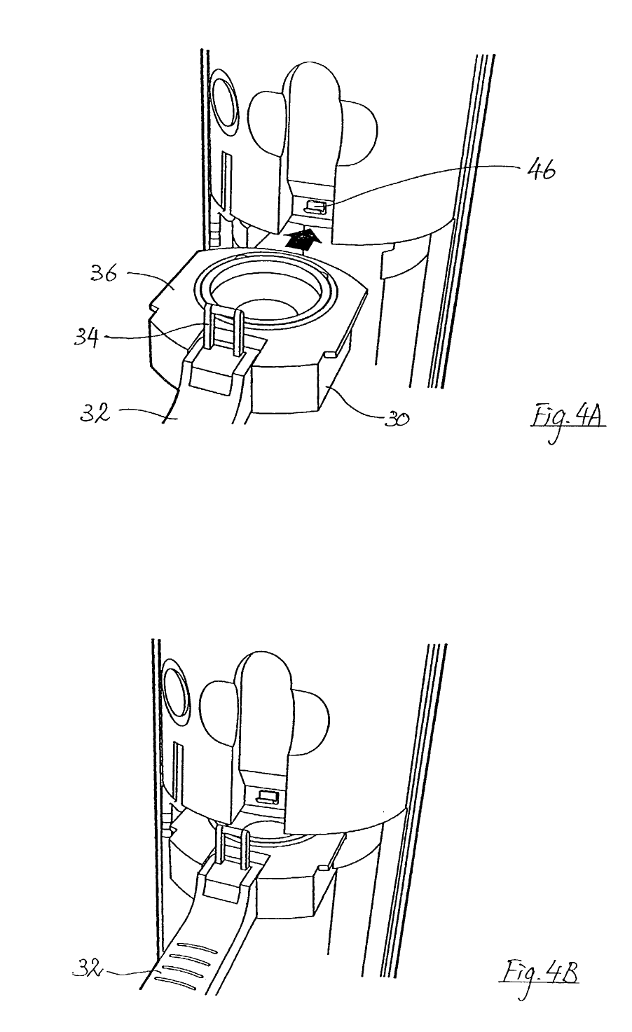

FIG. 3 is a side view of the boiler and coffee holder of the electric coffee maker shown in FIG. 1A, in an engaged yet unlocked position;

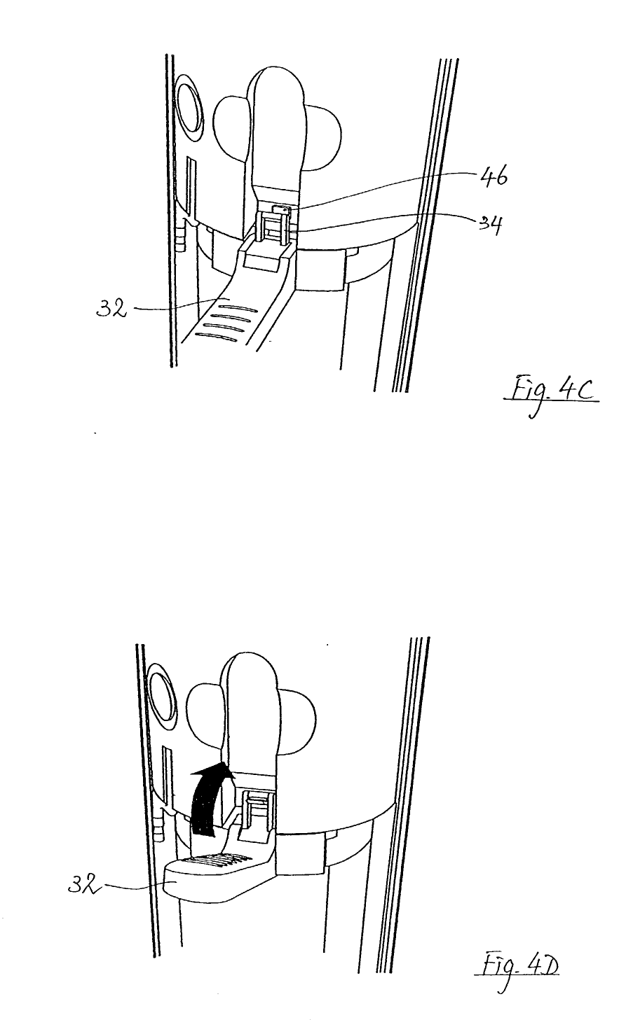

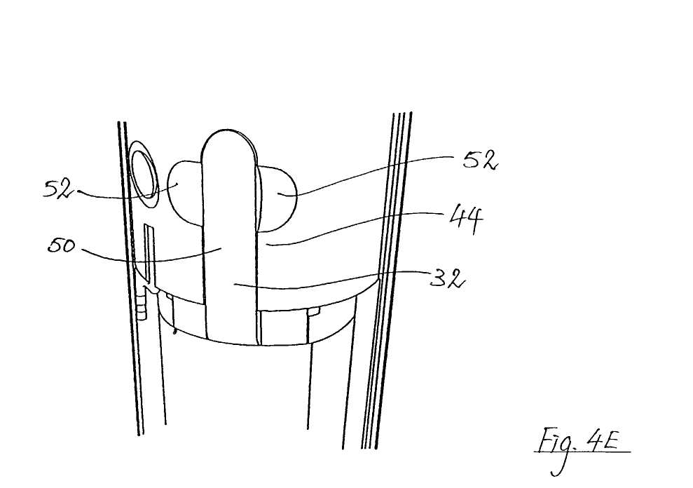

FIGS. 4A to 4E are perspective views showing the way in which the coffee holder and the boiler of the electric coffee maker shown in FIG. 1A are secured with each other; and

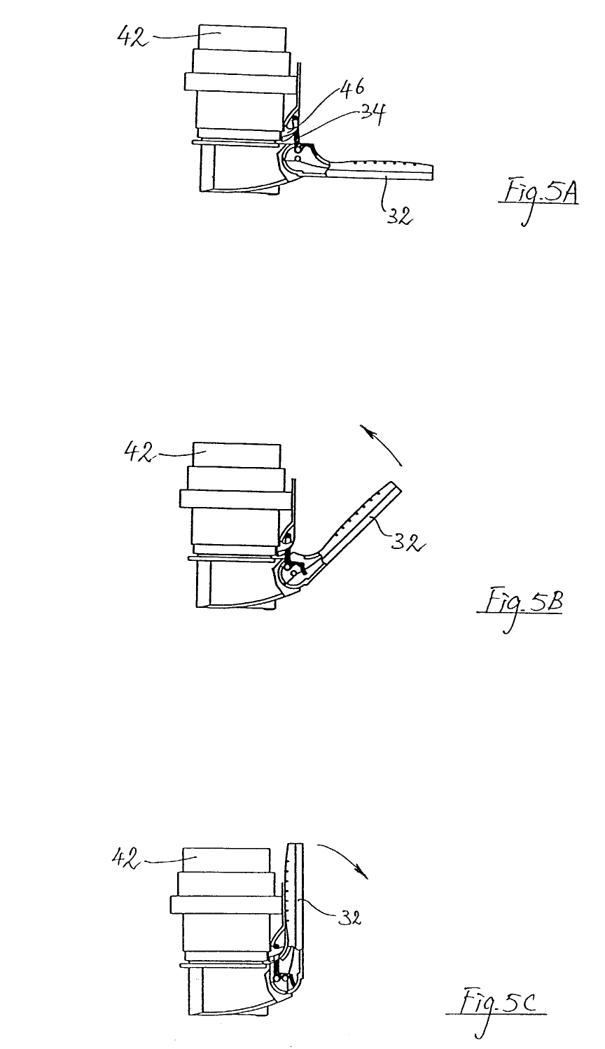

FIGS. 5A to 5C are side views showing the way in which the coffee holder and the boiler of the electric coffee maker shown in FIG. 1A are secured with each other.

FIGS. 1A to 1C show an electric coffee maker generally designated as 10, which may be used for making coffee, including cappuccino and espresso. The coffee maker 10 includes an outer casing 12 with two doors 14 which may be opened to allow access to a coffee making machine 16 housing within the casing 12. The coffee maker 10 also includes a table 18 which may be moved between a retracted position in which an upper surface 20 of the table 18 is enclosed fully within the casing 12 (as shown in FIG. 1A), and an extended position in which the table 18 at least part of the table 18 is outward of the casing 12 (as shown in FIG. 1C). In this extended position, a cup (not shown) may be placed on the upper surface 20 of the table 18 to receive coffee from the coffee making machine 16. The coffee making machine 16 includes a number of buttons 22a, 22b, 22c which are operable to control the operation of the coffee making machine 16. A number of lights 24a, 24b are also provided for indicating the state of operation of the coffee making machine 16.

As shown in FIG. 2, the coffee maker 10 includes a coffee holder 30 with a handle 32, a catch 34, and a container 36. The container 36 has a top end with an upwardly facing opening through which ground coffee or coffee powder may be placed in the container 36 for boiling by the coffee making machine 16, in a manner to be discussed below. The handle 32, the catch 34, and the container 36 are movable relative to one another. In particular, the handle 32 is pivotally movable relative to the container 36 about an axis 38, and the catch 34 is pivotally movable relative to the handle 32 about an axis 40. The catch 34 is provided with an opening 41, the function of which will be discussed below.

The coffee maker 10 also includes a boiler 42 housed within a plastic housing 44, of which only part is shown in FIG. 2. Extending outwardly and upwardly from the boiler 42 is a hook 46. The boiler 42 has a lower end with a downwardly facing opening. A silicone rubber seal 48 is provided around the opening of the boiler 42. As can be seen in FIG. 3, the upper end of the container 36 may be engaged with the lower end of the boiler 42 in a liquid communicable manner, so that the ground coffee or coffee powder may be heated and dissolved in water from the boiler 42. When the coffee holder 30 is secured with the boiler 42 (in a manner to be discussed below), the silicone rubber seal 48 forms a water-tight seal between the boiler 42 and the coffee holder 30, which ensures that the water will not escape from the coffee making machine 16. It is also envisaged that the silicone rubber seal 48 may instead be provided around the upwardly facing opening of the container 36.

As shown in FIGS. 4A to 4E, to secure the coffee holder 30 with the boiler 42, the coffee holder 30 is towards the boiler 42, in the direction indicated by the arrow in FIG. 4A, until the opening of the container 36 is underneath the opening of the boiler 42. The coffee holder 30 is then moved upward towards the boiler 42 until the silicone rubber seal 48 is fit within the opening of the container 36. The catch 34 is then moved relative to the container 36 and the handle 32 towards the hook 46, until the hook 46 is received within the opening 41 of the catch 34. The handle 32 is then pivoted upward in the direction of the arrow in FIG. 4D until its outer surface 50 is generally co-planar with the surrounding plastic housing 44, with the exception of two recesses 52, which allow a user to pivot the handle 32 downwardly to unlock the coffee holder 30 from the boiler 42.

When the hook 46 is received within the catch 34 (as shown in FIG. 5A), pivoting of the handle 32 upwardly in the direction indicated by the arrow in FIG. 5B will bring the catch 34 downward to contact and bear on an upper surface of the hook 46, as shown in FIG. 5C. In this way, the coffee holder 30 is secured to the boiler 42 against any relative movement therebetween. To unlock the coffee holder 30 from the boiler 42, one needs simply to pivot the handle 32 downwardly in the direction indicated by the arrow in FIG. C. The catch 34 will then be moved upward and out of contact with the hook 46. The catch 34 may then be moved away from the hook 46, which allows the coffee holder 30 to be disengaged from the boiler 42.

It should be understood that the above only illustrates an example whereby the present invention may be carried out, and that various modifications and/or alterations may be made thereto without departing from the spirit of the invention. It should also be understood that various features of the invention which are now, for brevity, described in the context of a single embodiment, may be provided separately or in any appropriate sub-combinations.

1. A mechanism for releasably securing a first article and a second article with each other, wherein said first article includes a handle member, an engagement member and a container member with an upwardly facing opening, wherein said handle member is movable relative to said container member, wherein said engagement member includes an aperture and is movable relative to said handle member, wherein said second article includes a downwardly facing opening and an outwardly extending engagement element, wherein said upwardly facing opening of said container member is adapted to be engaged with said downwardly facing opening of said second article, wherein said engagement element of said second article is adapted to be received within said aperture of said engagement member of said first article when said upwardly facing opening of said container member is engaged with said downwardly facing opening of said second article.

2. A mechanism according to claim 1 wherein said engagement member of said first article is movable relative to said handle member.

3. A mechanism according to claim 1 wherein said engagement element of said second article comprises a hook member.

4. A mechanism according to claim 3 wherein said hook member extends generally upwardly.

5. A mechanism according to claim 3 wherein when said first article and said second article are secured with each other, said engagement member of said first article is in contact with said hook member.

6. A mechanism according to claim 5 wherein when said first article and said second article are secured with each other, said engagement member of said first article bears on an upper surface of said hook member.

7. A mechanism according to claim 6 wherein said handle member of said first article is movable relative to said container member to cause said engagement member of said first article to bear on said upper surface of said hook member.

8. A mechanism according to claim 1 wherein when said first article and said second article are secured with each other, at least part of said handle member of said first article is received within a recess of said second article.

9. A mechanism according to claim 1 wherein a sealing member is provided adjacent to said downwardly facing opening of said second article, or adjacent to said upwardly facing opening of said first article, which is adapted to form a liquid-tight seal between said first article and second article when said articles are secured with each other.

10. A method for releasably securing a first article and a second article with each other, wherein said first article includes a handle member, an engagement member and a container member with an upwardly facing opening, wherein said handle member is movable relative to said container member, wherein said engagement member includes an aperture and is movable relative to said handle member, wherein said second article includes a downwardly facing opening and an outwardly extending engagement element, including the steps of (a) engaging said upwardly facing opening of said container member with said downwardly facing opening of said second article to allow liquid to pass between said container member and said second article; (b) moving said engagement member to receive at least part of said engagement element within said aperture of said engagement member; and (c) moving said handle member to bring said engagement member into contact with said engagement element.

11. A method according to claim 10 including a step (d) of providing a sealing member adjacent to said downwardly facing opening of said second article.

12. A method according to claim 10 including a step (e) of providing a sealing member adjacent to said upwardly facing opening of said first article.

13. A method according to claim 10 wherein, in said step (c), said handle member is moved upwardly relative to said container member.

14. A method according to claim 13 wherein, in said step (c), said handle member is pivoted upwardly relative to said container member.

15. A method according to claim 13 wherein, when said handle member is moved upwardly relative to said container member, said engagement member is moved downwardly relative to said container member.

16. A method according to claim 15 wherein, when said handle member is moved upwardly relative to said container member, said engagement member is moved until said engagement member contacts an upper surface of said engagement element.

17. A beverage maker including a holder and a boiler which are releasably securable with each other, wherein said holder includes a handle member, an engagement member and a container member with an upwardly facing opening, wherein said handle member is movable relative to said container member, wherein said engagement member includes an aperture and is movable relative to said handle member, wherein said boiler includes a downwardly facing opening and an outwardly extending engagement element, wherein said upwardly facing opening of said container member is adapted to be engaged with said downwardly facing opening of said boiler, wherein said engagement element of said boiler is adapted to be received within said aperture of said engagement member of said holder when said upwardly facing opening of said container member is engaged with said downwardly facing opening of said boiler.

18. A beverage maker according to claim 17 wherein said beverage maker comprises a coffee maker.
